(19) United States
(12) Patent Application Publication
(10) Pub. No.: US 2024/0419291 A1
(43) Pub. Date: Dec. 19, 2024

(54) TASK PROCESSING METHOD, NON-TRANSITORY COMPUTER-READABLE STORAGE MEDIUM AND DEVICE

(71) Applicant: Beijing Zitiao Network Technology Co., Ltd., Beijing (CN)

(72) Inventor: Wenzong Ma, Beijing (CN)

(21) Appl. No.: 18/689,818

(22) PCT Filed: Sep. 22, 2022
(86) PCT No.: PCT/CN2022/120503

§ 371 Date: Mar. 6, 2024

(30) Foreign Application Priority Data
Sep. 22, 2021 (CN) 202111109356.5

(51) Int. Cl. G06F 3/0481; G06F 3/0484; G06F 40/166; G06Q 10/0631

(52) U.S. Cl. CPC G06F 3/0481; G06F 3/0484; G06F 40/166; G06Q 10/063114

(57) ABSTRACT

The embodiments of the present disclosure provide a task processing method and apparatus, which relates to an information processing field. The method includes: in response to receiving an input request of task information on a document page, displaying a task panel on the document page, the task panel comprising the task information; in response to a trigger operation on the task information in the task panel, displaying a task region on the document page, and displaying the task information and a state identifier in the task region, the state identifier being used for presenting a current state of a task. The embodiments of the present disclosure solve the problem that the current user is unable to quickly obtain the relevant status of the task.

### CROSS-REFERENCE TO RELATED APPLICATIONS

The present application claims priority to Chinese Patent Application No. 202111109356.5, filed on Sep. 22, 2021, entitled “TASK PROCESSING METHOD AND APPARATUS”, which is hereby incorporated by reference in its entirety.

### FIELD

The present invention relates to the field of information processing technology, and in particular, to a task processing method and apparatus.

### BACKGROUND

Objectives and key results (OKR) are a set of management tools and methods that define and track objectives and the completion of the objectives, and are intended to define “objectives” of companies and teams and define measurable “key results” for the achievement of the objectives.

In the prior art, an OKR management system may provide a user with OKR editing and presenting functions, and the user may perform operations such as editing and viewing OKR for the progress of OKR through the OKR management system. As discussed above, in the prior art, only OKR content is displayed during presentation of OKR, and display of other related states of OKR is not supported. However, apart from the progress of OKR, OKR further includes multiple very important states. When only OKR and the progress of OKR are presented, the user cannot quickly acquire related states of OKR.

### SUMMARY

In view of this, the present invention provides a task processing method and apparatus for solving the user is unable to quickly obtain the relevant state of the task.

To achieve the above object, embodiments of the present invention provide the following technical solutions:

In a first aspect, embodiments of the present invention provide a task processing method, the method comprising:

In response to receiving an input request of task information on a document page, displaying a task panel on the document page, the task panel comprising the task information;

In response to a trigger operation on the task information in the task panel, displaying a task region on the document page, and displaying the task information and a state identifier in the task region, wherein the state identifier is used for presenting a current state of a task.

As an optional implementation of the embodiments of the present disclosure, the state identifier comprises at least one of a score, progress, and a state.

As an optional implementation of the embodiments of the present disclosure, the displaying the task information and the state identifier in the task region comprises:

Acquiring state data corresponding to the task information in a task system;

Displaying the state identifier in the task region based on the state data.

As an optional implementation of the embodiments of the present disclosure, the task information comprises first task information and/or second task information, the first task information and the second task information have an association relationship, and each of the first task information and the second task information corresponds to one state identifier.

As an optional implementation of the embodiments of the present disclosure, in response to weight information having been configured for the first task information, the state identifier comprises a first state identifier, the first state identifier being used for representing progress and a state of the task.

As an optional implementation of the embodiments of the present disclosure, the method further comprises:

In response to an editing instruction for the first state identifier corresponding to the first task information or the second task information, displaying an editing interface, the editing interface comprising a state editing component and a progress editing component.

As an optional implementation of the embodiments of the present disclosure, the method further comprises:

In response to receiving a configuration operation on the state identifier, adding a second state identifier to the state identifier, the second state identifier being used for representing a score of the task.

As an optional implementation of the embodiments of the present disclosure,

In response to weight information having been configured for the second task information, the state identifier comprises a first state identifier and a second state identifier, the first state identifier is used for representing progress and a state of the task, and the second state identifier is used for representing a score of the task.

As an optional implementation of the embodiments of the present disclosure, the method further comprises:

In response to an editing instruction for the first state identifier corresponding to the second task information, displaying an editing interface, the editing interface comprising a state editing component and a progress editing component; or

In response to an editing instruction for the first state identifier corresponding to the first task information, displaying an editing interface, wherein the editing interface comprises a state editing component.

As an optional implementation of the embodiments of the present disclosure, the method further comprises:

In response to an editing operation on the progress editing component, determining progress data of the second task information;

Determining, based on the progress data, progress data of the first task information associated with the second task information, and displaying the progress data of the first task information in the first state identifier corresponding to the first task information.

As an optional implementation of the embodiments of the present disclosure, the method further comprises:

In response to a focus being located at the second state identifier, displaying first prompt information.

As an optional implementation of the embodiments of the present disclosure, the method further comprises:

In response to a focus being located at the second state identifier of the first task information and the first task information being associated with the second task information, displaying second prompt information; or

In response to a focus being located at the second state identifier of the first task information and the first task information being not associated with the second task information, if it is determined that identity information of an owner of the first task information is first identity information, displaying first prompt information, and if it is determined that the identity information of the owner of the first task information is second identity information, displaying second prompt information; or

In response to a focus being located at the second state identifier of the second task information, displaying first prompt information.

As an optional implementation of the embodiments of the present disclosure, the method further comprises:

In response to receiving an editing command for the second state identifier, changing the second state identifier into an editable state.

As an optional implementation of the embodiments of the present disclosure, the method further comprises:

In response to receiving an editing command for the second state identifier of the first task information and the first task information being associated with the second task information, making the second state identifier in a non-editable state; or

In response to receiving an editing command for the second state identifier of the first task information and the first task information being not associated with the second task information, if it is determined that identity information of an owner of the first task information is first identity information, changing the second state identifier into an editable state, and if it is determined that the identity information of the owner of the first task information is second identity information, making the second state identifier in a non-editable state; or

In response to receiving an editing command for the second state identifier of the second task information, changing the second state identifier into an editable state.

As an optional implementation of the embodiments of the present disclosure, the method further comprises:

In response to receiving an operation on a first control component in the task region, displaying a control panel, and in response to an operation on a setting item in the control panel, hiding the state identifier.

As an optional implementation of the embodiments of the present disclosure, the method further comprises:

The task region comprises a content editing region located near the task information.

As an optional implementation of the embodiments of the present disclosure, the method further comprises:

In response to receiving an operation on a second control component in the task region, sending data of the state identifier and/or data of the content editing region to a task system.

As an optional implementation of the embodiments of the present disclosure, the sending the data of the state identifier and/or the data of the content editing region to the task system comprises:

In response to the second task information being hidden, forbidding sending the data of the state identifier and/or the data of the content editing region corresponding to the second task information to the task system; or

In response to the second task information being hidden, sending the data of the state identifier and/or the data of the content editing region corresponding to the first task information associated with the second task information to the task system.

As an optional implementation of the embodiments of the present disclosure, the sending the data of the state identifier and/or the data of the content editing region to the task system comprises:

In response to the state identifier and/or the content editing region being hidden, forbidding sending the data of the state identifier and/or the data of the content editing region to the task system.

As an optional implementation of the embodiments of the present disclosure, the method further comprises, the method further comprises:

In response to the state identifier and the content editing region being hidden, displaying the second control component in a first display state; or

In response to the state identifier being hidden and there being no data in the content editing region, displaying the second control component in a first display state; or

In response to the state identifier and the second task information being hidden, displaying the second control component in a first display state.

In a second aspect, embodiments of the present invention provide a task processing apparatus, the apparatus comprising:

A processing module, for in response to receiving an input request of task information on a document page, displaying a task panel on the document page, the task panel comprising the task information;

A displaying module, for in response to a trigger operation on the task information in the task panel, displaying a task region on the document page, and displaying the task information and a state identifier in the task region, the state identifier being used for presenting a current state of a task.

As an optional implementation of the embodiments of the present disclosure, the state identifier comprises at least one of a score, progress, and a state.

As an optional implementation of the embodiments of the present disclosure, the displaying module is specifically used for acquiring state data corresponding to the task information in a task system; displaying the state identifier in the task region based on the state data.

As an optional implementation of the embodiments of the present disclosure, the task information comprises first task information and/or second task information, the first task information and the second task information have an association relationship, and each of the first task information and the second task information corresponds to one state identifier.

As an optional implementation of the embodiments of the present disclosure, in response to weight information having been configured for the first task information, the state identifier comprises a first state identifier, the first state identifier being used for representing progress and a state of the task.

As an optional implementation of the embodiments of the present disclosure, the displaying module is further used for in response to an editing instruction for the first state identifier corresponding to the first task information or the second task information, displaying an editing interface, the editing interface comprising a state editing component and a progress editing component.

As an optional implementation of the embodiments of the present disclosure, the displaying module is further used for in response to receiving a configuration operation on the state identifier, adding a second state identifier to the state identifier, the second state identifier being used for representing a score of the task.

As an optional implementation of the embodiments of the present disclosure, in response to weight information having been configured for the second task information, the state identifier comprises a first state identifier and a second state identifier, the first state identifier is used for representing progress and a state of the task, and the second state identifier is used for representing a score of the task.

As an optional implementation of the embodiments of the present disclosure, the displaying module is further used for in response to an editing instruction for the first state identifier corresponding to the second task information, displaying an editing interface, the editing interface comprising a state editing component and a progress editing component; or,

In response to an editing instruction for the first state identifier corresponding to the first task information, displaying an editing interface, wherein the editing interface comprises a state editing component.

As an optional implementation of the embodiments of the present disclosure, the displaying module is further used for in response to an editing operation on the progress editing component, determining progress data of the second task information; determining, based on the progress data, progress data of the first task information associated with the second task information, and displaying the progress data of the first task information in the first state identifier corresponding to the first task information.

As an optional implementation of the embodiments of the present disclosure, the displaying module is further used for in response to a focus being located at the second state identifier, displaying first prompt information.

As an optional implementation of the embodiments of the present disclosure, the displaying module is further used for in response to a focus being located at the second state identifier of the first task information and the first task information being associated with the second task information, displaying second prompt information; or,

In response to a focus being located at the second state identifier of the first task information and the first task information being not associated with the second task information, if it is determined that identity information of an owner of the first task information is first identity information, displaying first prompt information, and if it is determined that the identity information of the owner of the first task information is second identity information, displaying second prompt information; or

In response to a focus being located at the second state identifier of the second task information, displaying first prompt information.

As an optional implementation of the embodiments of the present disclosure, the displaying module is further used for in response to receiving an editing command for the second state identifier, changing the second state identifier into an editable state.

As an optional implementation of the embodiments of the present disclosure, the displaying module is further used for in response to receiving an editing command for the second state identifier of the first task information and the first task information being associated with the second task information, making the second state identifier in a non-editable state; or,

In response to receiving an editing command for the second state identifier of the first task information and the first task information being not associated with the second task information, if it is determined that identity information of an owner of the first task information is first identity information, changing the second state identifier into an editable state, and if it is determined that the identity information of the owner of the first task information is second identity information, making the second state identifier in a non-editable state; or,

In response to receiving an editing command for the second state identifier of the second task information, changing the second state identifier into an editable state.

As an optional implementation of the embodiments of the present disclosure, the displaying module is further used for in response to receiving an operation on a first control component in the task region, displaying a control panel, and in response to an operation on a setting item in the control panel, hiding the state identifier.

As an optional implementation of the embodiments of the present disclosure, the task region comprises a content editing region located near the task information.

As an optional implementation of the embodiments of the present disclosure, the task processing apparatus further comprises:

A sending module, for in response to receiving an operation on a second control component in the task region, sending data of the state identifier and/or data of the content editing region to a task system.

As an optional implementation of the embodiments of the present disclosure, the sending module is specifically used for:

In response to the second task information being hidden, forbidding sending the data of the state identifier and/or the data of the content editing region corresponding to the second task information to the task system; or,

In response to the second task information being hidden, sending the data of the state identifier and/or the data of the content editing region corresponding to the first task information associated with the second task information to the task system.

As an optional implementation of the embodiments of the present disclosure, the sending module is specifically used for:

In response to the state identifier and/or the content editing region being hidden, forbidding sending the data of the state identifier and/or the data of the content editing region to the task system.

As an optional implementation of the embodiments of the present disclosure, the displaying module is further used for:

In response to the state identifier and the content editing region being hidden, displaying the second control component in a first display state; or

In response to the state identifier being hidden and there being no data in the content editing region, displaying the second control component in a first display state; or

In response to the state identifier and the second task information being hidden, displaying the second control component in a first display state.

In a third aspect, embodiments of the present invention provide an electronic device, comprising: a memory and a processor, the memory for storing a computer program; the processor for calling the computer program, causing the electronic device to implement the task processing method of the first aspect or any optional implementation of the first aspect.

In a fourth aspect, embodiments of the present invention provide a computer-readable storage medium, when the computer program being executed by a computing device, causing the computing device to implement the task processing method of the first aspect or any optional implementation of the first aspect.

In a fifth aspect, embodiments of the present invention provide a computer program product, when the computer program product being run on a computer, causes the computer to implement the task processing method of the first aspect or any optional implementation of the first aspect.

The task processing method provided by the embodiment of the present disclosure first displays a task panel including the task information in the document page in response to receiving an input request for task information in the document page, and then displays a task area in the document page in response to a triggering operation of the task information in the task panel. Since the task area displays task information and a status identifier for presenting the current state of the task, the user can quickly obtain the current state of the task according to the status identifier to solve the problem that the user is unable to quickly obtain the relevant state of the task.

### BRIEF DESCRIPTION OF THE SEVERAL VIEWS OF THE DRAWINGS

The accompanying drawings are incorporated in the description and constitute a part of the description, show embodiments conforming to the present invention, and are used together with the specification to explain the principle of the present invention.

For clearer descriptions of the technical solutions in the embodiments of the present invention or the prior art, the following briefly introduces the accompanying drawings required for describing the embodiments or the prior art. Apparently, persons of ordinary skill in the art may still derive other drawings from these accompanying drawings without creative efforts.

FIG. 1 is a step flowchart 1 of a task processing method according to an embodiment of the present invention;

FIG. 2 is a schematic diagram 1 of a scenario interface according to an embodiment of the present invention;

FIG. 3 is a schematic diagram 2 of a scenario interface according to an embodiment of the present invention;

FIG. 4 is a schematic diagram 3 of a scenario interface according to an embodiment of the present invention;

FIG. 5 is a schematic diagram 4 of a scenario interface according to an embodiment of the present invention;

FIG. 6 is a schematic diagram 5 of a scenario interface according to an embodiment of the present invention;

FIG. 7 is a schematic diagram 6 of a scenario interface according to an embodiment of the present invention;

FIG. 8 is a schematic diagram 7 of a scenario interface according to an embodiment of the present invention;

FIG. 9 is a schematic diagram 8 of a scenario interface according to an embodiment of the present invention;

FIG. 10 is a schematic diagram 9 of a scenario interface according to an embodiment of the present invention;

FIG. 11 is a schematic diagram 10 of a scenario interface according to an embodiment of the present invention;

FIG. 12 is a schematic diagram 11 of a scenario interface according to an embodiment of the present invention;

FIG. 13 is a schematic diagram 12 of a scenario interface according to an embodiment of the present invention;

FIG. 14 is a schematic diagram 13 of a scenario interface according to an embodiment of the present invention;

FIG. 15 is a schematic diagram 14 of a scenario interface according to an embodiment of the present invention;

FIG. 16 is a schematic diagram 15 of a scenario interface according to an embodiment of the present invention;

FIG. 17 is a schematic diagram 16 of a scenario interface according to an embodiment of the present invention;

FIG. 18 is a schematic diagram 1 of a task processing apparatus according to an embodiment of the present invention;

FIG. 19 is a schematic diagram 2 of a task processing apparatus according to an embodiment of the present invention; and

FIG. 20 is a schematic diagram of a hardware structure of an electronic device according to an embodiment of the present invention.

### DETAILED DESCRIPTION

In order to better understand the above objectives, features, and advantages of the present invention, the following will further describe the solutions of the present invention. It should be noted that, without conflict, the embodiments and features of the present invention may be combined with each other.

Many specific details are set forth in the following description in order to fully understand the present invention, but the present invention may also be implemented in other ways different from those described herein; obviously, the embodiments in the specification are only part of the embodiments of the present invention, not all embodiments.

In the embodiment of the present invention, words such as “exemplary” or “for example” are used to indicate examples, illustrations, or explanations. Any embodiment or design described as “exemplary” or “for example” in the embodiment of the present invention should not be construed as being more preferred or advantageous than other embodiments or designs. Specifically, the use of words such as “exemplary” or “for example” is intended to present relevant concepts in a specific way. In addition, in the description of the embodiment of the present invention, unless otherwise specified, the meaning of “multiple” refers to two or more.

The execution subject of the task processing method in the embodiment of the present invention may be a mobile phone, a tablet computer, a laptop computer, an ultra-mobile personal computer (UMPC), a netbook, a personal digital assistant (PDA), a smart watch, smart bracelet and other terminal devices, or the execution subject of the task processing method may also be other types of terminal devices. The embodiments of the present application are not limited in this regard.

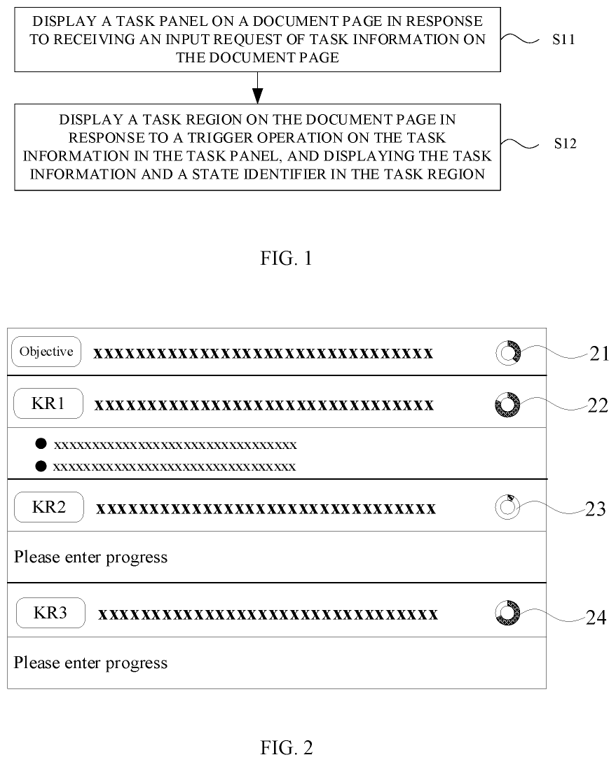

Embodiments of the present invention provide a task processing method. With reference to FIG. 1, the task processing method includes steps S11 and S12 as follows.

In S11, a task panel is displayed on a document page in response to receiving an input request of task information on the document page.

Herein, the task panel includes the task information.

The document page in the embodiments of the present invention may be a page of any document, for example, a presentation page of a progress report, an editing page of the progress report, a presentation page of a periodic retrospective document, an editing page of an ordinary document, or the like. The document page is not limited in the embodiments of the present invention, provided that the document page supports selection or search of a task.

Exemplarily, the task in the embodiments of the present invention may be OKR. The information about the task may be related information of OKR.

In S12, a task region is displayed on the document page in response to a trigger operation on the task information in the task panel, and the task information and a state identifier are displayed in the task region.

The state identifier is used for presenting a current state of the task.

Specifically, the trigger operation on the task information is an operation of confirming task information to be selected. The operation may be specifically a tap operation, a voice instruction, or a specific gesture on a task identifier. In some embodiments of the present invention, the specific gesture may be any one of a single tap gesture, a swipe gesture, a pressure recognition gesture, a long-press gesture, an area change gesture, a double press gesture, and a double tap gesture.

As an optional implementation mode of the embodiments of the present invention, the state identifier includes at least one a score, progress, and a state.

Specifically, the score in the embodiments of the present invention is used for representing a quality score of a task. The score may be any value in a preset score range, for example, may be any value in [0, 100]. The progress is used for representing a level of completion of a task. The progress may be any value in [0%, 100%]. The state is used for representing an implementation state of a task. The state may include: normal, risky, delayed, and the like.

In the task processing method provided in the embodiments of the present invention, the task panel including the task information is first displayed on the document page in response to receiving an input request of the task information on the document page, and then a task region is displayed on the document page in response to a trigger operation on the task information in the task panel. The task information and a state identifier used for presenting a current state of a task are displayed in the task region. Therefore, a user may quickly acquire the current state of the task based on the state identifier, to resolve the problem that the user cannot quickly acquire related states of the task.

As an optional implementation mode of the embodiments of the present invention, the step that the task information and the state identifier are displayed in the task region includes step a and step b as follows.

In step a, state data corresponding to the task information in a task system is acquired.

In the embodiments of the present invention, the task system is a system that records all task information of the user. The user may acquire, based on registration, an account for logging on to the task system, and log onto the task system based on the account for logging onto the task system. It should be noted that the account for logging onto the task system and an account for logging onto a document have an association relationship, and a client of the task system and a client of the document may be the same client, or may be different clients.

In some embodiments, an implementation mode of acquiring the state data corresponding to the task information in the task system may include: sending, to the task system, request information used for requesting the state data corresponding to the task information, and receiving the state data corresponding to the task information sent by the task system.

In step b, the state identifier is displayed in the task region based on the state data.

That is, the client needs to acquire current state data of the task from the task system, to display the state identifier of the task in the task region.

As an optional implementation mode of the embodiments of the present invention, the task information includes first task information and/or second task information, the first task information and the second task information have an association relationship, and each of the first task information and the second task information corresponds to one state identifier.

Optionally, the first task information may be an objective of OKR, and the second task information may be a key result of OKR.

In a case that the task information includes the first task information and the second task information, the first task information is objective of OKR, and the second task information is a key result of OKR, the objective of OKR correspond to one state identifier, and each key result of OKR corresponds to one state identifier.

As an optional implementation mode of the embodiments of the present invention, in the task processing method provided in the embodiments of the present invention,
in response to weight information having been configured for the first task information, the state identifier includes a first state identifier, and the first state identifier is used for representing progress and a state of the task.

An optional implementation mode of the embodiments of the present invention, the first state identifier represents the state of the task with a filling color, and the progress of the task with a filling proportion. For example, filling colors of green, yellow, and red may be respectively used to represent time limit states being normal, risky, and delayed, and a filling proportion being 50% may be used to represent that the progress of the task is 50%.

Exemplarily, with reference to FIG. 2, an example in which the task is OKR, the first task information is an objective of OKR, the second task information is a key result of OKR, and the second task information includes a first key result KR1, a second key result KR2, and a third key result KR3 is used in FIG. 2 to describe the foregoing embodiments. In a case that weight information of the objectives of OKR is configured, the state identifier includes: a first state identifier 21 used for representing progress and a state of the objective of OKR, a first state identifier 22 used for representing progress and a state of the first key result KR1 of OKR, a first state identifier 23 used for representing progress and a state of the second key result KR2 of OKR, and a first state identifier 24 used for representing progress and a state of the third key result KR3 of OKR.

Further, in a case that the weight information of the first task information is configured and the state identifier includes the first state identifier used for representing the progress and the state of the task, the task processing method provided in the embodiments of the present invention further includes:
in response to an editing instruction for the first state identifier corresponding to the first task information or the second task information, displaying an editing interface.

The editing interface includes a state editing component and a progress editing component.

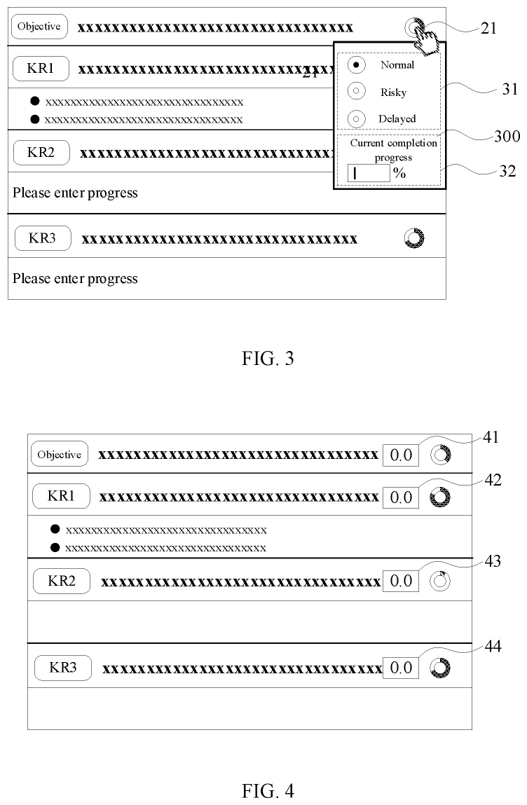

Exemplarily, with reference to FIG. 3, an example in which the state identifier includes the first state identifier 21 corresponding to the objective of OKR, the first state identifier corresponding to the first key result KR1 of OKR, the first state identifier corresponding to the second key result KR2 of OKR, and the first state identifier corresponding to the third key result KR31 of OKR is used to describe the foregoing embodiment in FIG. 3. When receiving the editing instruction entered by the user for the first state identifier 21 corresponding to the objective of OKR, the client displays, in response to the editing instruction for the first state identifier 21 corresponding to the objective of OKR, an editing interface 300 used for editing the objective of OKR. The editing interface 300 includes a state editing component 31 and a progress editing component 32. The user may edit the state and/or the progress of the objective of OKR via the state editing component 31 and/or the progress editing component 32.

Further, in a case that the weight information of the first task information is configured, the task processing method provided in the embodiments of the present invention further includes:
in response to receiving a configuration operation on the state identifier, adding a second state identifier to the state identifier.

The second state identifier is used for representing a score of the task.

Exemplarily, with reference to FIG. 4, in FIG. 4, an example in which the task is OKR, the first task information is an objective of OKR, the second task information is a key result of OKR, and the second task information includes a first key result KR1, a second key result KR2, and a third key result KR3 is used to describe the foregoing embodiments. In a case that the weight information of the objective of OKR is configured and the configuration operation on the state identifier by the user is received, the client further adds, to the state identifier in response to receiving the configuration operation on the state identifier, a second identifier 41 used for representing a score of the objective of OKR, a second identifier 42 used for representing a score of the first key result KR1 of OKR, a second identifier 43 used for representing a score of the second key result KR2 of OKR, and a second identifier 44 used for representing a score of the third key result KR3 of OKR.

As an optional implementation mode of the embodiments of the present invention, the task processing method provided in the embodiments of the present invention further comprises:
in response to weight information having been configured for the second task information, the state identifier includes a first state identifier and a second state identifier.

The first state identifier is used for representing progress and a state of the task, and the second state identifier is used for representing a score of the task.

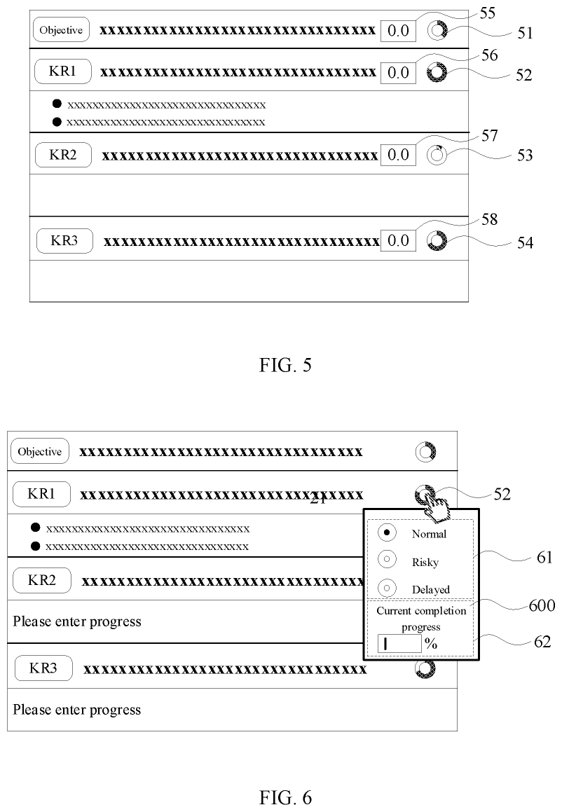

Exemplarily, with reference to FIG. 5, an example in which the task is OKR, the first task information is an objective of OKR, the second task information is a key result of OKR, and the second task information includes a first key result KR1, a second key result KR2, and a third key result KR3 is used in FIG. 5 to describe the foregoing embodiments. In a case that weight information of the key result of OKR is configured, the state identifier includes: a first state identifier 51 used for representing progress and a state of the objective of OKR, a first state identifier 52 used for representing progress and a state of the first key result KR1 of OKR, a first state identifier 53 used for representing progress and a state of the second key result KR2 of OKR, a first state identifier 54 used for representing progress and a state of the third key result KR3 of OKR, a second identifier 55 used for representing a score of the objective of OKR, a second identifier 56 used for representing a score of the first key result KR1 of OKR, a second identifier 57 used for representing a score of the second key result KR2 of OKR, and a second identifier 58 used for representing a score of the third key result KR3 of OKR.

Further, in a case that the weight information of the second task information is configured and the state identifier includes the first state identifier used for representing the progress and the state of the task, the task processing method provided in the embodiments of the present invention further includes:
in response to an editing instruction for the first state identifier corresponding to the second task information, displaying an editing interface.

The editing interface includes a state editing component and a progress editing component.

Exemplarily, with reference to FIG. 6, an example the state identifier includes the first state identifier corresponding to the objective of OKR, the first state identifier 52 corresponding to the first key result KR1 of OKR, the first state identifier corresponding to the second key result KR2 of OKR, the first state identifier corresponding to the third key result KR3 of OKR, the second identifier corresponding to the objective of OKR, the second identifier corresponding to the first key result KR1 of OKR, the second identifier corresponding to the second key result KR2 of OKR, and the second identifier corresponding to the third key result KR3 of OKR is used in FIG. 6 to describe the foregoing embodiment. When receiving the editing instruction entered by the user for the first state identifier 52 corresponding to the first key result KR1 of OKR, the client displays, in response to the editing instruction for the first state identifier 52 corresponding to the first key result KR1 of OKR, an editing interface 600 used for editing the first key result KR1 of OKR. The editing interface 600 includes a state editing component 61 and a progress editing component 62. The user may edit the state and/or the progress of the first key result KR1 of OKR via the state editing component 61 and/or the progress editing component 62.

Further, in a case that the weight information of the second task information is configured and the state identifier includes the first state identifier used for representing the progress and the state of the task, the task processing method provided in the embodiments of the present invention further includes:
in response to an editing instruction for the first state identifier corresponding to the first task information, displaying an editing interface.

The editing interface includes a state editing component.

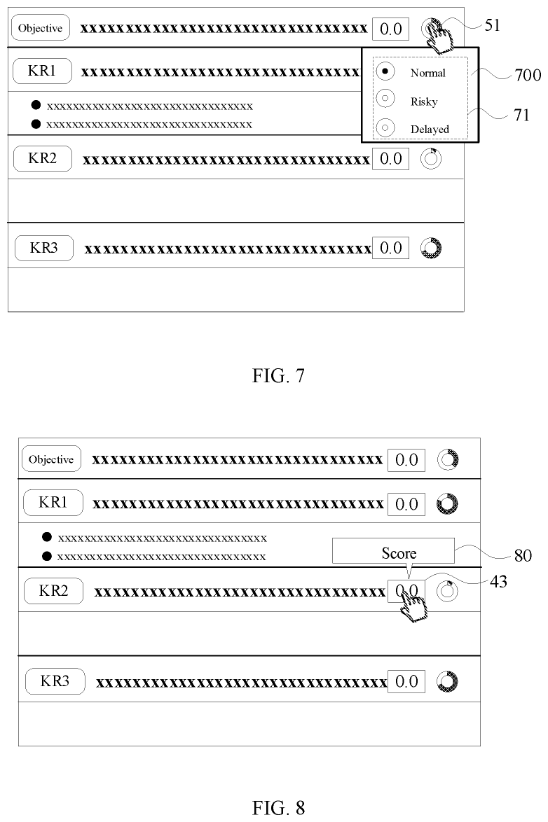

Exemplarily, with reference to FIG. 7, an example the state identifier includes the first state identifier 51 corresponding to the objective of OKR, the first state identifier corresponding to the first key result KR1 of OKR, the first state identifier corresponding to the second key result KR2 of OKR, the first state identifier corresponding to the third key result KR3 of OKR, the second identifier corresponding to the objective of OKR, the second identifier corresponding to the first key result KR1 of OKR, the second identifier corresponding to the second key result KR2 of OKR, and the second identifier corresponding to the third key result KR3 of OKR is used in FIG. 7 to describe the foregoing embodiment. When receiving the editing instruction entered by the user for the first state identifier 51 corresponding to the objective of OKR, the client displays, in response to the editing instruction for the first state identifier 51 corresponding to the objective of OKR, an editing interface 700 used for editing the objective of OKR. The editing interface 700 includes a state editing component 71. The user may edit the state of the objective of OKR via the state editing component 71.

Further, after the editing interface is displayed in response to the editing instruction for the first state identifier corresponding to the first task information, the task processing method provided in the embodiments of the present invention further includes:
in response to an editing operation on the progress editing component, determining progress data of the second task information; and
determining, based on the progress data, progress data of the first task information associated with the second task information, and displaying the progress data of the first task information in the first state identifier corresponding to the first task information.

That is, in a case that the weight information of the second task information is configured, only the progress of the second task information can be edited, and the progress of the first task information cannot be directly edited. However, after the progress of the second task information is edited, the client automatically calculates, updates and displays the progress data of the first task information based on the progress and the weight information of the second task information.

As an optional implementation mode of the embodiments of the present invention, in a case that the weight information of the first task information is configured and the second state identifier used for representing the score of the task is added to the state identifier, the task processing method provided in the embodiments of the present invention further includes:
in response to a focus being located at the second state identifier, displaying first prompt information.

That is, regardless of whether the focus is located at the second state identifier used for representing the score of the first task information or the focus is located at the second state identifier used for representing the score of the second task information, the first prompt information is displayed.

Exemplarily, the first prompt information may be used for prompting the meaning represented by the second state identifier. For example, the first prompt information may be “points”, “score”, or the like.

Exemplarily, with reference to FIG. 8, in a case that the second identifier corresponding to the objective of OKR, the second identifier of the score corresponding to the first key result KR1 of OKR, the second identifier 43 of the score corresponding to the second key result KR2 of OKR, and the second identifier corresponding to the third key result KR3 of OKR are added to the state identifier, when the focus is located at the second identifier 43 of the score corresponding to the second key result KR2 of OKR, the client displays first prompt information 80, and content of the first prompt information 80 is “score”.

As an optional implementation mode of the embodiments of the present invention, in a case that the weight information of the second task information is configured, the task processing method provided in the embodiments of the present invention further includes:
in response to a focus being located at the second state identifier of the first task information and the first task information being associated with the second task information, displaying second prompt information.

Exemplarily, the second prompt information may be used for prompting a generation manner of the score represented by the second state identifier. For example, the second prompt information may be “calculated through a weight and a score of the associated second task information”, “automatically calculated”, or the like.

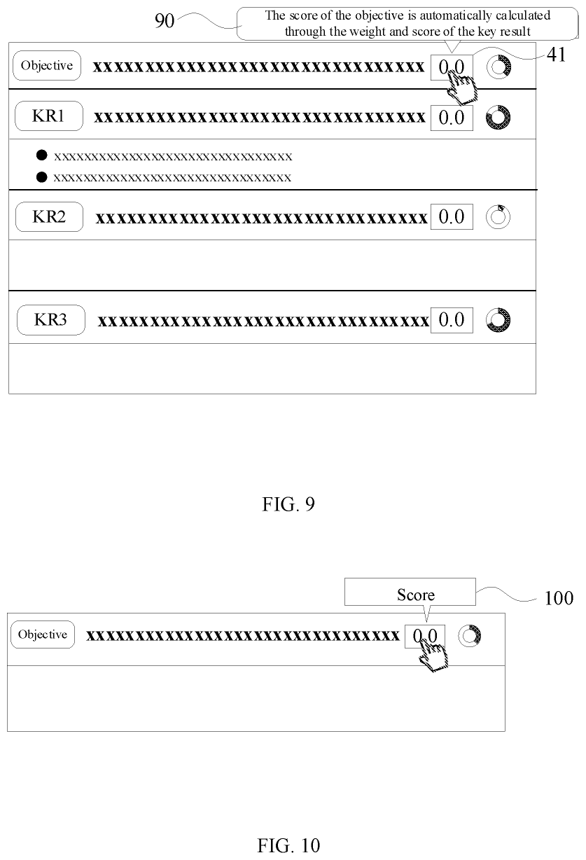

Exemplarily, with reference to FIG. 9, in a case that the weight information of the key result of OKR is configured and the objective of OKR has the key result KR1, the key result KR2, and the key result KR3, when the focus is located at the second identifier 41 corresponding to the objective of OKR, the client displays second prompt information 90. Content of the second prompt information 90 is “the score of the objective is automatically calculated through the weight and score of the key result”.

As an optional implementation mode of the embodiments of the present invention, in a case that the weight information of the second task information is configured, the task processing method provided in the embodiments of the present invention further includes:
in response to a focus being located at the second state identifier of the first task information and the first task information being not associated with the second task information, if it is determined that identity information of an owner of the first task information is first identity information, displaying first prompt information, and if it is determined that the identity information of the owner of the first task information is second identity information, displaying second prompt information.

Specifically, the first identity information may be identity information of a member who belongs to a specified company, group or organization, and the second identity information may be identity information of a member who does not belong to a specified company, group or organization.

Exemplarily, with reference to FIG. 10, in a case that the weight information of the key result of OKR is configured, the objective of OKR does not have a key result, and identity information of an owner of OKR is the first identity information, when the focus is located at the second identifier corresponding to the objective of OKR, the client displays first prompt information 100. Content of the first prompt information 100 is “score”.

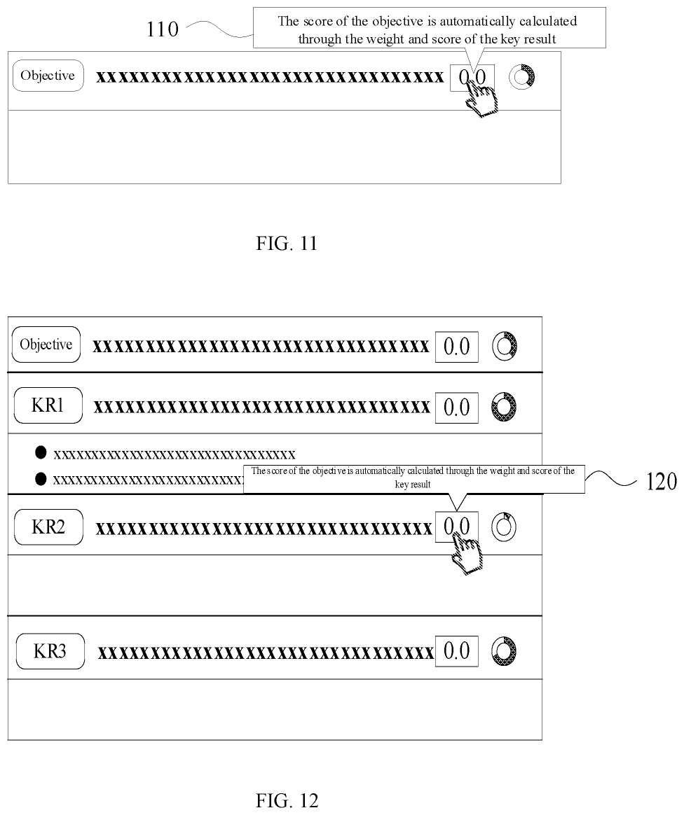

Exemplarily, with reference to FIG. 11, in a case that the weight information of the key result of OKR is configured, the objective of OKR does not have a key result, and the identity information of the owner of OKR is the second identity information, when the focus is located at the second identifier corresponding to the objective of OKR, the client displays second prompt information 110. Content of the second prompt information 110 is “the score of the objective is automatically calculated through the weight and score of the key result”.

As an optional implementation mode of the embodiments of the present invention, in a case that the weight information of the second task information is configured, the task processing method provided in the embodiments of the present invention further includes:
in response to a focus being located at the second state identifier of the second task information, displaying first prompt information.

Exemplarily, with reference to FIG. 12, in a case that the weight information of the key result of OKR is configured, when the focus is located at the second identifier corresponding to the key result of OKR, the client displays first prompt information 120. Content of the first prompt information 120 is “the score of the objective is automatically calculated through the weight and score of the key result”.

As an optional implementation mode of the embodiments of the present invention, in a case that the weight information of the first task information is configured and the second state identifier used for representing the score of the task is added to the state identifier, the task processing method provided in the embodiments of the present invention further includes:
in response to receiving an editing command for the second state identifier, changing the second state identifier into an editable state.

That is, in a case that the weight information of the first task information is configured, the second state identifiers of the first task information and the second task information are both editable.

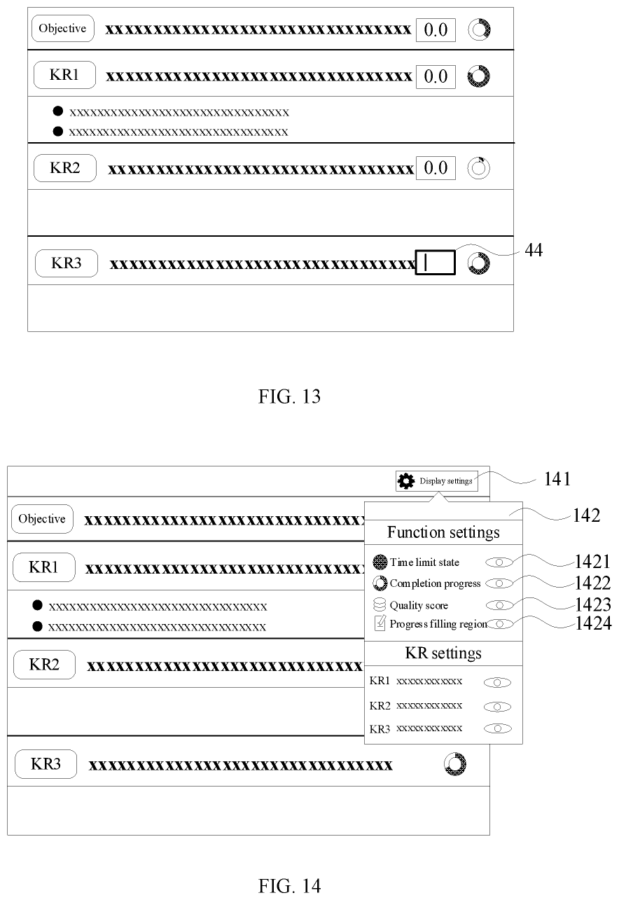

Exemplarily, with reference to FIG. 13, in a case that the weight information of the objective of OKR is configured, when an editing command for a third state identifier 44 corresponding to the key result KR3 of OKR is received, the third state identifier 44 corresponding to the key result KR3 of OKR is changed into an editable state.

As an optional implementation mode of the embodiments of the present invention, in a case that the weight information of the second task information is configured, the task processing method provided in the embodiments of the present invention further includes:
in response to receiving an editing command for the second state identifier of the first task information and the first task information being associated with the second task information, making the second state identifier in a non-editable state.

Exemplarily, making the second state identifier in the non-editable state may specifically means that the second state identifier may be set to gray, a display state of the second state identifier remains unchanged, and the like.

That is, in a case that the weight information of the second task information is configured and the first task information is associated with the second task information, editing of the second state identifier of the first task information is not supported.

As an optional implementation mode of the embodiments of the present invention, in a case that the weight information of the second task information is configured, the task processing method provided in the embodiments of the present invention further includes:
in response to receiving an editing command for the second state identifier of the first task information and the first task information being not associated with the second task information, if it is determined that identity information of an owner of the first task information is first identity information, changing the second state identifier into an editable state, and if it is determined that the identity information of the owner of the first task information is second identity information, making the second state identifier in a non-editable state.

That is, in a case that the weight information of the second task information is configured and the first task information is not associated with the second task information, if the identity information of the owner of the first task information is the first identity information, editing of the second state identifier of the first task information is supported; and if the identity information of the owner of the first task information is the second identity information, editing of the second state identifier of the first task information is not supported.

As an optional implementation mode of the embodiments of the present invention, in a case that the weight information of the second task information is configured, the task processing method provided in the embodiments of the present invention further includes:
in response to receiving an editing command for the second state identifier of the second task information, changing the second state identifier into an editable state.

That is, in a case that the weight information of the second task information is configured, editing of the second state identifier of the second task information is supported.

As an optional implementation mode of the embodiments of the present invention, the task processing method provided in the embodiments of the present invention further includes:
in response to receiving an operation on a first control component in the task region, displaying a control panel, and in response to an operation on a setting item in the control panel, hiding the state identifier.

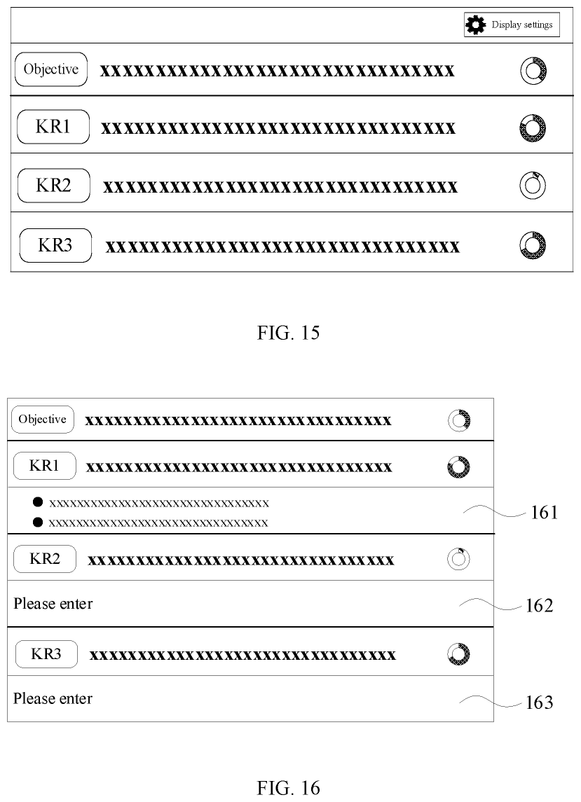

Exemplarily, with reference to FIG. 14, the task region further includes a first control component 141. When receiving an operation on the first control component 141, a control panel 142 is displayed in response to receiving the operation on the first control component in the task region. The control panel 142 includes: a setting item 1421 used for displaying or hiding a state, a setting item 1422 used for displaying or hiding progress, a setting item 1423 used for displaying or hiding a score, a setting item 1424 used for displaying or hiding a progress filling region, and setting items used for displaying or hiding key results of OKR. When the operation on the setting item in the control panel 142 is received, the corresponding state identifier is hidden. Further, with reference to FIG. 15, when operations on the setting items 1423 and 1424 in the control panel 142 are received, the objective of OKR and the score of the key result are hidden, and the progress filling region of the key result of OKR is hidden.

As an optional implementation mode of the embodiments of the present invention, the task region includes a content editing region, and the content editing region is located near the task information.

Optionally, when the content editing region is located near the task information, it may be that the distance between the content editing region and the task information is less than a preset distance.

Optionally, the content editing region is an extended region. The extended region may be an adjacent region located at corresponding task information.

Exemplarily, with reference to FIG. 16, an example in which the task region includes a content editing region 161 of the first key result KR1 of OKR, a content editing region 162 of the second key result KR2 of OKR, and a content editing region 163 of the third the key result KR3 of OKR, and the content editing regions are all located below corresponding key results is shown in FIG. 16.

As an optional implementation mode of the embodiments of the present invention, the task processing method provided in the embodiments of the present invention further includes:
in response to receiving an operation on a second control component in the task region, sending data of the state identifier and/or data of the content editing region to the task system.

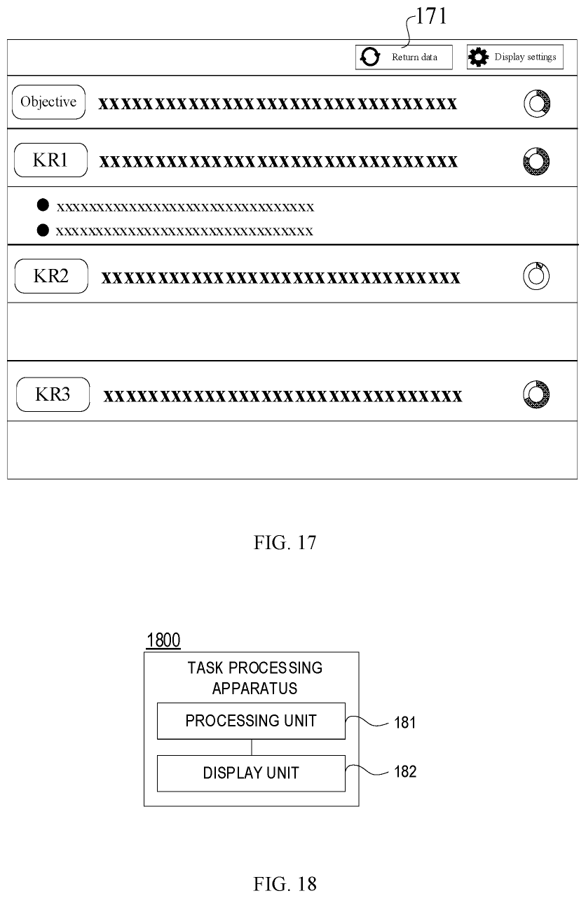

Exemplarily, with reference to FIG. 17, the task region further includes a second control component 171. When an operation on the second control component 171 is received, the data of the state identifier and/or the data of the content editing region are sent to the task system.

As an optional implementation mode of the embodiments of the present invention, sending the data of the state identifier and/or the data of the content editing region to the task system includes:
in response to the second task information being hidden, forbidding sending the data of the state identifier corresponding to the second task information and/or the data of the content editing region to the task system.

For example, if the first key result of OKR is hidden, when the operation on the second control component in the task region is received, related data of the key result is not sent to the task system.

As an optional implementation mode of the embodiments of the present invention, sending the data of the state identifier and/or the data of the content editing region to the task system includes:
in response to the second task information being hidden, sending the data of the state identifier corresponding to the first task information associated with the second task information and/or the data of the content editing region to the task system.

For example, if the first key result of OKR is hidden, when the operation on the second control component in the task region is received, related data of the objective of OKR is sent to the task system.

As an optional implementation mode of the embodiments of the present invention, sending the data of the state identifier and/or the data of the content editing region to the task system includes:
in response to the state identifier and/or the content editing region being hidden, forbidding sending the data of the state identifier and/or the data of the content editing region to the task system.

For example, if the score of OKR is hidden, when the operation on the second control component in the task region is received, the score of OKR is not sent to the task system.

As an optional implementation mode of the embodiments of the present invention, the task processing method provided in the embodiments of the present invention further includes:
in response to the state identifier and the content editing region being hidden, displaying the second control component in a first display state; or
in response to the state identifier being hidden and there being no data in the content editing region, displaying the second control component in a first display state; or
in response to the state identifier and the second task information being hidden, displaying the second control component in a first display state.

Exemplarily, the first display state may be a “set to gray” state.

When the state identifier and the content editing region are hidden or the state identifier is hidden and there is no data in the content editing region, or the state identifier and the second task information are hidden, the second control component is displayed in the first display state, such that the user can be kept from frequently triggering return of data to the task system, thereby reducing network resources consumed by the client.

Based on the same inventive concept, as an implementation of the above methods, embodiments of the present invention also provide a task processing apparatus, the apparatus corresponding to the embodiments of the method embodiments. For ease of discussion, the present embodiments of the apparatus are no longer the details of the method embodiments described one by one. However, it should be clear that the task processing apparatus in the present embodiment may correspond to implement all the contents of the method embodiments.

Embodiments of the present invention provide a task processing apparatus. FIG. 18 is a schematic structural diagram of the task processing apparatus. As shown in FIG. 18, the task processing apparatus 1800 includes:

A processing module181, for in response to receiving an input request of task information on a document page, displaying a task panel on the document page, the task panel comprising the task information;

A displaying module 182, for in response to a trigger operation on the task information in the task panel, displaying a task region on the document page, and displaying the task information and a state identifier in the task region, the state identifier being used for presenting a current state of a task.

As an optional implementation of the embodiments of the present disclosure, the state identifier comprises at least one of a score, progress, and a state.

As an optional implementation of the embodiments of the present disclosure, the displaying module 182 is specifically used for acquiring state data corresponding to the task information in a task system; displaying the state identifier in the task region based on the state data.

As an optional implementation of the embodiments of the present disclosure, the task information comprises first task information and/or second task information, the first task information and the second task information have an association relationship, and each of the first task information and the second task information corresponds to one state identifier.

As an optional implementation of the embodiments of the present disclosure, in response to weight information having been configured for the first task information, the state identifier comprises a first state identifier, the first state identifier being used for representing progress and a state of the task.

As an optional implementation of the embodiments of the present disclosure, the displaying module 182 is further used for in response to an editing instruction for the first state identifier corresponding to the first task information or the second task information, displaying an editing interface, the editing interface comprising a state editing component and a progress editing component.

As an optional implementation of the embodiments of the present disclosure, the displaying module 182 is further used for in response to receiving a configuration operation on the state identifier, adding a second state identifier to the state identifier, the second state identifier being used for representing a score of the task.

As an optional implementation of the embodiments of the present disclosure, in response to weight information having been configured for the second task information, the state identifier comprises a first state identifier and a second state identifier, the first state identifier is used for representing progress and a state of the task, and the second state identifier is used for representing a score of the task.

As an optional implementation of the embodiments of the present disclosure, the displaying module 182 is further used for in response to an editing instruction for the first state identifier corresponding to the second task information, displaying an editing interface, the editing interface comprising a state editing component and a progress editing component; or,

In response to an editing instruction for the first state identifier corresponding to the first task information, displaying an editing interface, wherein the editing interface comprises a state editing component.

As an optional implementation of the embodiments of the present disclosure, the displaying module 182 is further used for in response to an editing operation on the progress editing component, determining progress data of the second task information; determining, based on the progress data, progress data of the first task information associated with the second task information, and displaying the progress data of the first task information in the first state identifier corresponding to the first task information.

As an optional implementation of the embodiments of the present disclosure, the displaying module 182 is further used for in response to a focus being located at the second state identifier, displaying first prompt information.

As an optional implementation of the embodiments of the present disclosure, the displaying module 182 is further used for in response to a focus being located at the second state identifier of the first task information and the first task information being associated with the second task information, displaying second prompt information; or,

In response to a focus being located at the second state identifier of the first task information and the first task information being not associated with the second task information, if it is determined that identity information of an owner of the first task information is first identity information, displaying first prompt information, and if it is determined that the identity information of the owner of the first task information is second identity information, displaying second prompt information; or

In response to a focus being located at the second state identifier of the second task information, displaying first prompt information.

As an optional implementation of the embodiments of the present disclosure, the displaying module 182 is further used for in response to receiving an editing command for the second state identifier, changing the second state identifier into an editable state.

As an optional implementation of the embodiments of the present disclosure, the displaying module 182 is further used for in response to receiving an editing command for the second state identifier of the first task information and the first task information being associated with the second task information, making the second state identifier in a non-editable state; or,

In response to receiving an editing command for the second state identifier of the first task information and the first task information being not associated with the second task information, if it is determined that identity information of an owner of the first task information is first identity information, changing the second state identifier into an editable state, and if it is determined that the identity information of the owner of the first task information is second identity information, making the second state identifier in a non-editable state; or,

In response to receiving an editing command for the second state identifier of the second task information, changing the second state identifier into an editable state.

As an optional implementation of the embodiments of the present disclosure, the displaying module 182 is further used for in response to receiving an operation on a first control component in the task region, displaying a control panel, and in response to an operation on a setting item in the control panel, hiding the state identifier.

As an optional implementation of the embodiments of the present disclosure, the method further comprises:

The task region comprises a content editing region located near the task information.

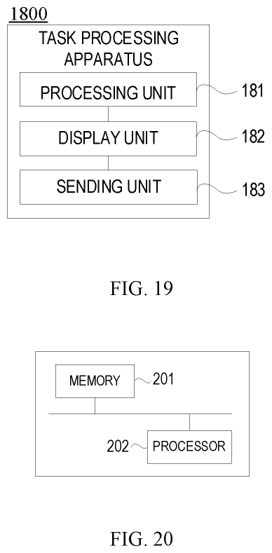

As an optional implementation of the embodiments of the present disclosure, As shown in FIG. 19, the task processing apparatus 1800 further comprises:

A sending module 183, for in response to receiving an operation on a second control component in the task region, sending data of the state identifier and/or data of the content editing region to a task system.

As an optional implementation of the embodiments of the present disclosure, the sending module is specifically used for: in response to the second task information being hidden, forbidding sending the data of the state identifier and/or the data of the content editing region corresponding to the second task information to the task system; or,

In response to the second task information being hidden, sending the data of the state identifier and/or the data of the content editing region corresponding to the first task information associated with the second task information to the task system.

As an optional implementation of the embodiments of the present disclosure, the sending module 183 is specifically used for: in response to the state identifier and/or the content editing region being hidden, forbidding sending the data of the state identifier and/or the data of the content editing region to the task system.

As an optional implementation of the embodiments of the present disclosure, the displaying module 182 is further used for: in response to the state identifier and the content editing region being hidden, displaying the second control component in a first display state; or in response to the state identifier being hidden and there being no data in the content editing region, displaying the second control component in a first display state; or

In response to the state identifier and the second task information being hidden, displaying the second control component in a first display state.

Based on the same inventive concept, the present invention also provides an electronic device. FIG. 20 is a schematic diagram of the structure of the electronic device provided by the present invention. As shown in FIG. 20, the electronic device provided by the present embodiment includes: a memory 201 and a processor 202. The memory 201 is used to store a computer program; the processor 202 is used to execute the task processing method provided by the above embodiment when calling the computer program.

Based on the same inventive concept, embodiments of the present invention further provide a computer-readable storage medium, the computer program stored on the computer-readable storage medium, when the computer program is executed by a processor, so that the computing device implements the above-described embodiment provides task processing method.

Based on the same inventive concept, embodiments of the present invention further provide a computer program product, when the computer program product is run on a computer, such that the computing device implements the task processing method provided in the above embodiment.

Those skilled in the art will appreciate that embodiments of the present invention may be provided as a method, system, or computer program product. Accordingly, the present invention may take the form of an entirely hardware embodiment, an entirely software embodiment, or an embodiment combining software and hardware aspects.

The processor may be a Central Processing Unit (CPU), as well as other general-purpose processor, Digital Signal Processor (DSP), Application Specific Integrated Circuit (ASIC), ready-made programmable gate array (FPGA), or other programmable logic devices, discrete gate or transistor logic devices, discrete hardware components, etc. The general-purpose processor can be a microprocessor or any conventional processor.

Memory may include non-persistent memory, random access memory (RAM), and/or non-volatile memory in computer-readable media, such as read-only memory (ROM) or flash memory (flash RAM). Memory is an example of a computer-readable medium.

Computer-readable media includes permanent and non-permanent, removable and non-removable storage media. Storage media can be implemented by any method or technology to store information, which can be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (PROEEM), flash memory or other memory technologies, CD-ROM, digital versatile disc (DVD) or other optical storage, magnetic cassette tape, disk storage or other magnetic storage devices, or any other non-transmission media that can be used to store information that can be accessed by computing devices. As defined herein, computer-readable media does not include transitory media, such as modulated data signals and carrier waves.

Finally, it should be noted that: the above embodiments are only used to illustrate the technical solutions of the present invention, and not to limit them; although the present invention has been described in detail with reference to the foregoing embodiments, those of ordinary skill in the art should understand that: it is still possible to the technical solutions described in the foregoing embodiments are modified, or some or all of the technical features are equivalently replaced; and these modifications or substitutions do not make the essence of the corresponding technical solutions depart from the scope of the technical solutions of the embodiments of the present invention.

1. A task processing method, comprising:
in response to receiving an input request of task information on a document page, displaying a task panel on the document page, the task panel comprising the task information; and
in response to a trigger operation on the task information in the task panel, displaying a task region on the document page, and displaying the task information and a state identifier in the task region, wherein the state identifier is used for presenting a current state of a task.

2. The method according to claim 1, wherein the state identifier comprises at least one of a score, progress, and a state,
or wherein the task region comprises a content editing region located near the task information,
or wherein the task information comprises first task information and/or second task information, the first task information and the second task information have an association relationship, and each of the first task information and the second task information corresponds to one state identifier.

3. The method according to claim 1, wherein displaying the task information and the state identifier in the task region comprises:
acquiring state data corresponding to the task information in a task system; and
displaying the state identifier in the task region based on the state data.

4. (canceled)

5. The method according to claim 2, wherein in response to weight information having been configured for the first task information, the state identifier comprises a first state identifier, the first state identifier being used for representing progress and a state of the task.

6. The method according to claim 5, further comprising:
in response to an editing instruction for the first state identifier corresponding to the first task information or the second task information, displaying an editing interface, the editing interface comprising a state editing component and a progress editing component.

7. The method according to claim 5, further comprising:
in response to receiving a configuration operation on the state identifier, adding a second state identifier to the state identifier, the second state identifier being used for representing a score of the task.

8. The method according to claim 2, wherein in response to weight information having been configured for the second task information, the state identifier comprises a first state identifier and a second state identifier, the first state identifier is used for representing progress and a state of the task, and the second state identifier is used for representing a score of the task.

9. The method according to claim 8, further comprising:
in response to an editing instruction for the first state identifier corresponding to the second task information, displaying an editing interface, the editing interface comprising a state editing component and a progress editing component; or
in response to an editing instruction for the first state identifier corresponding to the first task information, displaying an editing interface, wherein the editing interface comprises a state editing component.

10. The method according to claim 9, further comprising:
in response to an editing operation on the progress editing component, determining progress data of the second task information;
determining, based on the progress data, progress data of the first task information associated with the second task information, and displaying the progress data of the first task information in the first state identifier corresponding to the first task information.

11. The method according to claim 7, further comprising:
in response to a focus being located at the second state identifier, displaying first prompt information.

12. The method according to claim 8, further comprising:
in response to a focus being located at the second state identifier of the first task information and the first task information being associated with the second task information, displaying second prompt information; or
in response to a focus being located at the second state identifier of the first task information and the first task information being not associated with the second task information, if it is determined that identity information of an owner of the first task information is first identity information, displaying first prompt information, and if it is determined that the identity information of the owner of the first task information is second identity information, displaying second prompt information; or
in response to a focus being located at the second state identifier of the second task information, displaying first prompt information.

13. The method according to claim 7, further comprising:
in response to receiving an editing command for the second state identifier, changing the second state identifier into an editable state.

14. The method according to claim 8, further comprising:
in response to receiving an editing command for the second state identifier of the first task information and the first task information being associated with the second task information, making the second state identifier in a non-editable state; or
in response to receiving an editing command for the second state identifier of the first task information and the first task information being not associated with the second task information, if it is determined that identity information of an owner of the first task information is first identity information, changing the second state identifier into an editable state, and if it is determined that the identity information of the owner of the first task information is second identity information, making the second state identifier in a non-editable state; or
in response to receiving an editing command for the second state identifier of the second task information, changing the second state identifier into an editable state.

15. The method according to claim 1, further comprising:
in response to receiving an operation on a first control component in the task region, displaying a control panel, and in response to an operation on a setting item in the control panel, hiding the state identifier.

16. (canceled)

17. The method according to claim 1, further comprising:
in response to receiving an operation on a second control component in the task region, sending data of the state identifier and/or data of the content editing region to a task system.

18. The method according to claim 17, wherein sending the data of the state identifier and/or the data of the content editing region to the task system comprises:
in response to the second task information being hidden, forbidding sending the data of the state identifier and/or the data of the content editing region corresponding to the second task information to the task system; or
in response to the second task information being hidden, sending the data of the state identifier and/or the data of the content editing region corresponding to the first task information associated with the second task information to the task system.

19. The method according to claim 17, wherein sending the data of the state identifier and/or the data of the content editing region to the task system comprises:
in response to the state identifier and/or the content editing region being hidden, forbidding sending the data of the state identifier and/or the data of the content editing region to the task system.

20. The method according to claim 1, further comprising:
in response to the state identifier and the content editing region being hidden, displaying the second control component in a first display state; or
in response to the state identifier being hidden and there being no data in the content editing region, displaying the second control component in a first display state; or
in response to the state identifier and the second task information being hidden, displaying the second control component in a first display state.

21-24. (canceled)

25. An electronic device comprising:
a processor; and
a memory for storing a computer program;
wherein the computer program, when executed by the processor, causes the electronic device to perform operations comprising:
in response to receiving an input request of task information on a document page, displaying a task panel on the document page, the task panel comprising the task information; and
in response to a trigger operation on the task information in the task panel, displaying a task region on the document page, and displaying the task information and a state identifier in the task region, wherein the state identifier is used for presenting a current state of a task.

26. A non-transitory computer-readable storage medium, wherein the computer readable-storage medium stores instructions which, when executed on an electronic device, cause the electronic device to perform operations comprising:
in response to receiving an input request of task information on a document page, displaying a task panel on the document page, the task panel comprising the task information; and
in response to a trigger operation on the task information in the task panel, displaying a task region on the document page, and displaying the task information and a state identifier in the task region, wherein the state identifier is used for presenting a current state of a task.
